(19) United States
(12) Patent Application Publication
(10) Pub. No.: US 2008/0259524 A1
(43) Pub. Date: Oct. 23, 2008

(54) PROCESS FOR MANUFACTURING A HIGH-STABILITY CAPACITOR AND CORRESPONDING CAPACITOR

(75) Inventor: Serge Blonkowski, Meylan (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: STMicroelectronics (Crolles 2) SAS, Crolles (FR)

(21) Appl. No.: 12/105,334

(22) Filed: Apr. 18, 2008

(30) Foreign Application Priority Data
Apr. 19, 2007 (FR) 0754581

(51) Int. Cl. H01G 4/20; H01G 7/00

(52) U.S. Cl. 361/312; 29/25.42

(57) ABSTRACT

A dielectric alloy is composed of two dielectric materials that respectively have second-order non-linear dielectric susceptibilities with opposite signs. The composition is adjusted so that the alloy has a second-order non-linear dielectric susceptibility below a chosen threshold. A dielectric layer within an integrated circuit is made using the alloy. More specifically, an integrated capacitor is produced with a single-layer dielectric formed by said alloy.

### PRIORITY CLAIM

The present application is a translation of and claims priority from French Application for Patent No. 07 54581 of the same title filed Apr. 19, 2007, the disclosure of which is hereby incorporated by reference.

### BACKGROUND OF THE INVENTION

1. Technical Field of the Invention

The present invention relates to microelectronics, and more particularly to capacitors integrated into integrated circuits.

2. Description of Related Art

In microelectronics, it is advantageous to be able to integrate capacitors, for analog or radiofrequency applications, within functional blocks.

Generally, two predominant parameters are defined for a capacitor, which depend on the dielectric used, namely, on the one hand, the value of the capacitance per unit area, defined as the ratio of the capacitance to its surface area, and, on the other hand, the non-linearity which corresponds, for example, to the variation of the capacitive value as a function of the DC voltage applied to the terminals of the capacitor.

The higher the value of the capacitance per unit area, the lower the size of the capacitor for a given capacitance value.

Furthermore, in the case of an analog capacitor, the non-linearity is an important parameter. This is because the value of the capacitance must be as stable as possible regardless of the voltage applied to the terminals of the capacitor. The non-linearity of a capacitor depends on a factor which is proportional to the square of the voltage applied to the terminals of the capacitor. The coefficient of proportionality is a coefficient a known as the “second-order (or quadratic) non-linear voltage coefficient”.

The non-linearity may also be represented as being dependent on a factor proportional to the square of the electric field applied to the terminals of the capacitor. In this case, the coefficient of proportionality, γ, is the second-order (or quadratic) non-linear dielectric susceptibility.

The coefficients α and γ are related by the equation γ=αd², where d is the thickness of the dielectric of the capacitor.

In order to reduce the quadratic instability effect, low values are generally required for the coefficient α, for example of the order of 100 ppm/V².

When it is desired to increase the integration density, it is necessary to increase the capacitance per unit area. One solution for increasing the capacitance per unit area consists in reducing the thickness of the dielectric. This being, for one and the same material, and therefore for a given factor γ which is an intrinsic characteristic of the dielectric material used, a reduction in the thickness of the dielectric leading to an increase of the coefficient α, and therefore an increase in the instability.

It has been proposed to produce two-layer dielectrics formed from a layer of silicon dioxide and a layer of hafnium oxide (HfO₂) having coefficients γ of opposite signs respectively. However, in order to achieve the desired capacitive values, the silicon dioxide layer must have a very small thickness, typically of less than 4 nm. However, with such a value, the properties of the silica are difficult to control and dielectric breakdown occurs at low voltages. In addition, when two dielectric layers are brought into contact, an interfacial polarization phenomenon appears (known by the person skilled in the art under the name of the Maxwell-Wagner effect) that results in high losses and also in a high dependence of the capacitive value as a function of the variable electric field frequency.

There is therefore a need to produce capacitors having thin dielectrics, that have a low quadratic effect and are simple to produce.

### SUMMARY OF THE INVENTION

It is proposed, according to one mode of implementation, to use an alloy or a homogeneous mixture of two dielectric materials having coefficients γ of opposite signs, in order to form the single-layer dielectric of a capacitor. The composition of this alloy is then adjusted so that the resulting total coefficient γ has a value as close to 0 as possible, typically below a chosen threshold.

Thus, only a single material is formed for the dielectric, which is, on the one hand, simpler to produce and, on the other hand, avoids the formation of an interface. Furthermore, as the coefficient γ is as close to 0 as possible, the effect of the field on the quadratic voltage non-linearity is low, which makes it possible to produce thin capacitors with a small deviation from the linearity.

Accordingly, a process for manufacturing a capacitor is proposed in which the composition of a dielectric alloy comprising two dielectric materials that respectively have second-order non-linear dielectric susceptibilities with opposite signs is adjusted so as to obtain an alloy having a second-order dielectric susceptibility as close to 0 as possible, in practice below a chosen threshold, and the capacitor is produced with a single-layer dielectric formed by said alloy.

The quadratic (second-order) non-linear dielectric susceptibility γ of a material is equal to the product of the quadratic non-linear voltage coefficient α and the square of the thickness of the layer of said material. Furthermore, in practice, measurements of the variation in capacitive values are carried out for a dielectric material γ having a given thickness by varying the DC voltage which is applied thereto. Thus, for a single-layer dielectric material formed from the alloy mentioned above, and for a thickness of 10 nm, a threshold will advantageously be chosen for the coefficient a equal to 100 ppm.V⁻², which then corresponds to a threshold for the dielectric susceptibility γ of said alloy of the order of 100 ppm².cm².MV⁻², where MV denotes megavolts (10⁶ V).

Although numerous dielectric materials can be used to form said alloy, it is possible to advantageously choose, for the two dielectric materials of the alloy, an amorphous metal oxide and a silicon oxide.

The amorphous metal oxide may thus be obtained from a transition metal. It is recalled here, which is well known to a person skilled in the art, that a transition metal is chemically defined as an element which forms at least one ion with a partially filled d subshell. Thus, the thirty chemical elements of atomic number 21 to 30, 39 to 48 and 71 to 80 in the Periodic Table of the Elements form the transition metals.

According to one mode of implementation, the alloy has a composition A^{x}B₍₁₋ₓ₎ with x between 0 and 1, A denoting the amorphous metal oxide and B the silicon oxide, and the value of x is adjusted, where x may be of the order of a few hundredths.

Thus, the alloy is, for example, (ZrO₂)ₓ(SiO₂)₁₋ₓ with x of the order of 0.06.

According to another aspect, a process for manufacturing an integrated circuit is proposed that comprises manufacturing at least one capacitor according to the process such as defined hereinabove.

According to another aspect, a capacitor is proposed that comprises a single-layer dielectric formed from a dielectric alloy having a second-order non-linear dielectric susceptibility as close to 0 as possible, in practice below a chosen threshold and comprising two dielectric materials that respectively have second-order non-linear dielectric susceptibilities with opposite signs.

The threshold is, for example, of the order of 100 ppm.cm².MV⁻².

According to one embodiment, the two dielectric materials are an amorphous metal oxide and a silicon oxide.

The amorphous metal oxide is, for example, an oxide of a transition metal.

According to one embodiment, the alloy has a composition AₓB₍₁₋ₓ₎ with x between 0 and 1, A denoting the amorphous metal oxide and B the silicon oxide, and the value of x is of the order of a few hundredths.

For example, the alloy is (ZrO₂)ₓ(SiO₂)₁₋ₓ with x around 0.06.

According to another aspect, an integrated circuit is proposed comprising at least one capacitor such as defined hereinabove.

### BRIEF DESCRIPTION OF THE DRAWINGS

Other advantages and features of the invention will appear on examining the detailed description of modes of implementation and embodiments, which are in no way limiting, and the appended drawings in which:

FIG. 1 schematically illustrates a flowchart of a mode of implementing a process for manufacturing a capacitor;

FIG. 2 illustrates various curves of the relative variation of the capacitive value of a capacitor as a function of the voltage applied across its terminals;

FIG. 3 schematically illustrates one embodiment of a capacitor having a stable capacitive value; and

FIG. 4 schematically illustrates a change in the capacitance per unit area and in the quadratic factor of non-linearity γ as a function of the ZrO₂ proportion of a dielectric alloy.

### DETAILED DESCRIPTION OF THE DRAWINGS

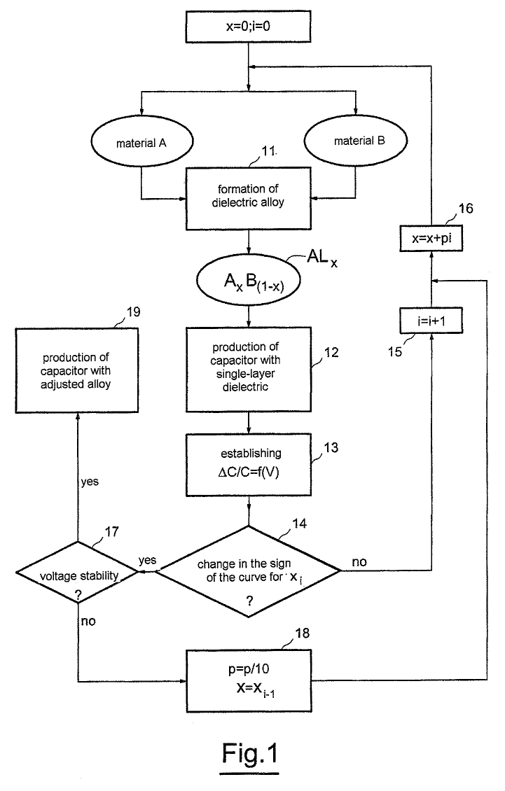

As illustrated in FIG. 1, two dielectric materials A and B having second-order (quadratic) non-linear dielectric susceptibilities γ with opposite signs are used to form a dielectric alloy (step 11) ALₓ of composition AₓB₍₁₋ₓ₎.

The two dielectric materials A and B may be, for example, an amorphous metal oxide and a silicon oxide respectively.

The amorphous metal oxide may be formed from a transition metal.

Among the transition metals used to form the amorphous metal oxide, mention may be made, non-exhaustively, of: Zr, Ti, Hf, Ta, Nb, Y, La, Pr, etc.

In fact, all the transition metals located in columns 3 to 6 inclusive of the Periodic Table of the Elements may be suitable.

The formation of the dielectric alloy may be carried out by several methods that are known per se, such as for example vapor phase deposition or else atomic layer deposition (ALD). More precisely, according to the latter mode of formation, it is possible to deposit, for example, alternately an atomic layer of metal (for example of zirconium Zr) by injecting an organometallic precursor (for example “TEMAZr”, that is to say Zr[N(CH₃)(C₂H₅)₃]₄) into a reactor followed by an injection of ozone to oxidize this layer. Thus, a metal oxide film is produced. The same procedure is followed for silicon oxide, using a suitable precursor (for example “Tri-DMA Si” that is to say SiH[N(CH₃)]₃) and ozone. The stoichiometry of the film is controlled by varying the number of single atomic layers of metal oxide and of silicon oxide which makes it possible to adjust the value of x.

Thus, a capacitor, such as that illustrated in FIG. 3, is produced (step 12) which is formed from a single-layer dielectric DL composed of the alloy ALₓ framed by two electrodes E1 and E2, for example made of titanium nitride TiN.

Next, a voltage V is applied between the two electrodes of the capacitor, which is varied over a given range and the capacitive value of the capacitor is measured for each of these voltage values which makes it possible to establish a curve representing the relative variation ΔC/C of this capacitive value as a function of the voltage V.

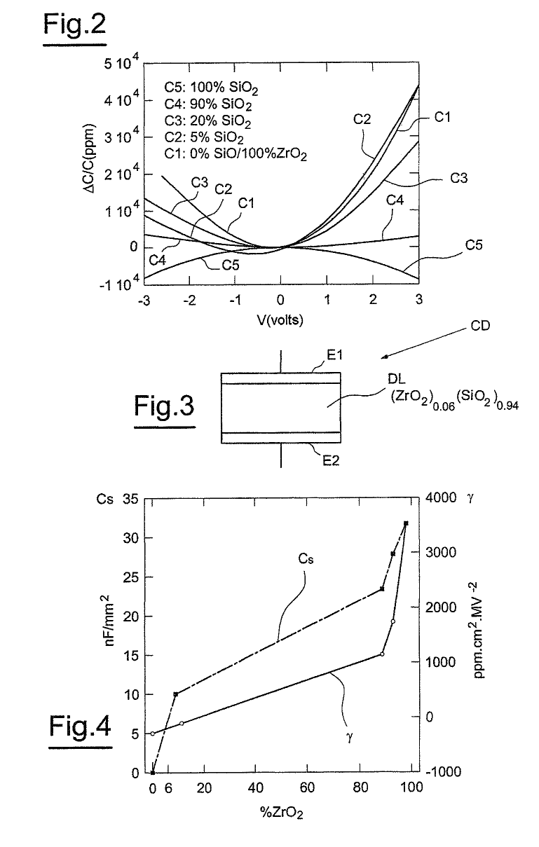

As illustrated in FIG. 2, since the relative capacitance ΔC/C is the sum of a linear voltage term and a V² term (involving the quadratic non-linear voltage coefficient α), the curve ΔC/C has a parabolic shape.

It would also be possible to represent the variation ΔC/C as a function of the voltage V² which would make it possible to obtain a straight line with a slope α.

In the example from FIG. 2, the alloy used comprises zirconium oxide ZrO₂ as a metal oxide and silicon oxide SiO₂.

Curve C1 shows the change in the relative capacitance as a function of the voltage for x=1 (pure zirconium oxide).

For curve C2, x is equal to 0.95.

For curve C3, x is equal to 0.8.

For curve C4, x is equal to 0.1.

For curve C5, x is zero (pure silicon oxide).

In step 14, it is observed whether a change in the sign of the curve between two successive values of x has been obtained, which amounts to observing whether there has been a change in the sign for the slope α.

If the sign has not changed, then the value of x is increased by a chosen increment p, for example of 0.1 (steps 15 and 16) and steps 11, 12, 13 and 14 are restarted.

In the case where a change in the sign of the curve for xᵢ for example (x=0.1 in the particular case from FIG. 2) has been observed, the operations 11, 12, 13 and 14 are restarted by dividing the increment typically by 5 or 10 (step 18) starting from the preceding composition up to a new value for which a again changes its sign.

All these operations are restarted until a voltage-stable capacitance is obtained (step 17), that is to say a capacitance having, for example, α coefficient a below 100 ppm V² for a dielectric thickness of 10 nm which corresponds to a threshold of 100 ppm.cm².MV⁻² for γ.

Then, the capacitor is produced with the alloy having the thus adjusted composition (step 19).

In the particular example described hereinabove, such a capacitor CD has a single-layer dielectric DL formed from 6% zirconium oxide and 94% silicon dioxide.

In FIG. 4, various values of the zirconium oxide composition, the change in the capacitance per unit area Cs and the change in γ are represented.

For 7% ZrO₂, the capacitance per unit area is 5.7 nF/mm² and the coefficient γ, close to 0, is equal to around 16.4 ppm.cm².MV⁻².

The thickness of the capacitor is 10 nm.

For a capacitive value of 8 nF/mm² having a high stability (γ˜16.4 ppm.cm².MV⁻²) and by using the same alloy, it is necessary that the capacitor has a thickness of around 7 nm. It would then be possible to have a coefficient α˜33.5 ppm/V². For a double capacitance of 11.4 nF/mm² corresponding to an alloy thickness of 5 nm, a coefficient α˜65 ppm/V² would be obtained.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A process for manufacturing an integrated capacitor, comprising: adjusting a composition of a dielectric alloy comprising two dielectric materials that respectively have second-order non-linear dielectric susceptibilities with opposite signs so as to obtain an alloy having a second-order non-linear dielectric susceptibility below a chosen threshold, and producing the capacitor with a single-layer dielectric formed by said alloy.

2. The process according to claim 1, in which the threshold is of the order of 100 ppm.cm².MV⁻².

3. The process according to claim 1, in which the two dielectric materials are an amorphous metal oxide and a silicon oxide.

4. The process according to claim 3, in which the amorphous metal oxide is formed from a transition metal.

5. The process according to claim 3, in which the alloy has a composition AₓB₍₁₋ₓ₎ with x between 0 and 1, wherein A denotes the amorphous metal oxide and B denotes the silicon oxide, and the value of x is adjusted.

6. The process according to claim 5, in which x is of the order of a few hundredths.

7. The process according to claim 1, in which the alloy is (ZrO₂)ₓ(SiO₂)₁₋ₓ with x around 0.06.

8. The process according to claim 1, wherein adjusting comprises:
separately producing overlying films of the two dielectric materials; and
selecting a number of each film to be separately produced so as to adjust stochiometry of the alloy.

9. The process according to claim 1, wherein adjusting comprises:
separately producing overlying films of metal oxide and silicon oxide to form the alloy having a composition AₓB₍₁₋ₓ₎; and
selecting a number of each film to be separately produced so as to adjust the value of x is adjusted; wherein A denotes the metal oxide and B denotes the silicon oxide.

10. A process for manufacturing an integrated circuit, comprising: adjusting a composition of a dielectric alloy comprising two dielectric materials that respectively have second-order non-linear dielectric susceptibilities with opposite signs so as to obtain an alloy having a second-order non-linear dielectric susceptibility below a chosen threshold, and producing a dielectric layer of the integrated circuit with said alloy.

11. The process according to claim 10, wherein the dielectric layer is a dielectric layer of a capacitor within the integrated circuit.

12. An integrated capacitor, comprising a single-layer dielectric formed from a dielectric alloy having a second-order non-linear dieletric susceptibility below a chosen threshold and comprising two dielectric materials that respectively have second-order non-linear dielectric susceptibilities with opposite signs.

13. The capacitor according to claim 12, in which the threshold is of the order of 100 ppm.cm².MV⁻².

14. The capacitor according to claim 12, in which the two dielectric materials are an amorphous metal oxide and a silicon oxide.

15. The capacitor according to claim 14, in which the amorphous metal oxide is an oxide of a transition metal.

16. The capacitor according to claim 14, in which the alloy has a composition AₓB₍₁₋ₓ₎ with x between 0 and 1, wherein A denotes the amorphous metal oxide and B denotes the silicon oxide, and the value of x is of the order of a few hundredths.

17. The capacitor according to claim 12, in which the alloy is (ZrO₂)ₓ(SiO₂)₁₋ₓ with x around 0.06 k.

18. The capacitor according to claim 12, wherein the single-layer dielectric comprises:
separately produced overlying films of the two dielectric materials, wherein a number of films separately produced adjusts stochiometry of the alloy.

19. The capacitor according to claim 12, wherein the single-layer dielectric comprises:
separately produced overlying films of metal oxide and silicon oxide forming the alloy having a composition AₓB₍₁₋ₓ₎, wherein a number films separately produced adjust the value of x and wherein A denotes the metal oxide and B denotes the silicon oxide.

20. An integrated circuit, comprising a single-layer dielectric formed from a dielectric alloy having a second-order non-linear dieletric susceptibility below a chosen threshold and comprising two dielectric materials that respectively have second-order non-linear dielectric susceptibilities with opposite signs.

21. The circuit according to claim 20, wherein the dielectric layer is a dielectric layer of a capacitor within the integrated circuit.
